(19) United States
(12) Patent Application Publication
(10) Pub. No.: US 2006/0097438 A1
(43) Pub. Date: May 11, 2006

(54) Adapter apparatus for a substrate workstation

(75) Inventor: Thomas Krieg, Solms (DE)

Correspondence Address: HOUSTON ELISEEVA, 4 MILITIA DRIVE, SUITE 4, LEXINGTON, MA, 02421, US

(73) Assignee: Leica Microsystems Semiconductor GmbH, Wetzlar (DE)

(21) Appl. No.: 11/265,872

(22) Filed: Nov. 3, 2005

(30) Foreign Application Priority Data
Nov. 5, 2004 (DE) DE 102004053906.5

(51) Int. Cl. B25B 1/02; B25B 5/02

(52) U.S. Cl. 269/203

(57) ABSTRACT

The present invention relates to an adapter apparatus for a substrate workstation. The substrate workstation comprises at least one substrate carrier that receives from one side in substantially centered fashion, for transport and/or for handling, a substrate to be processed with the substrate workstation. The intention is to allow substrates that permit contamination only in the edge region also to be processed, in the simplest possible fashion, using a substrate workstation embodied for the centered reception of substrates. The adapter apparatus according to the present invention is characterized in that the adapter apparatus is reversibly adaptable to a substrate carrier of the substrate workstation. The adapter apparatus is embodied in such a way that the substrate is receivable only substantially at its edge region by the adapter apparatus. The present invention further relates to a substrate workstation.

### RELATED APPLICATIONS

This application claims priority to German patent application number DE 10 2004 053 906.5-33, filed Nov. 5, 2004, which is incorporated herein by reference in its entirety.

### FIELD OF INVENTION

The present invention relates to an adapter apparatus for a substrate workstation. The substrate workstation comprises at least one substrate carrier that receives from one side in substantially centered fashion, for transport and/or for handling, a substrate to be processed with the substrate workstation. The present invention further relates to a substrate workstation.

### BACKGROUND OF THE INVENTION

The substrates involved are on the one hand disk-shaped wafers that are usually made of silicon or gallium arsenide. Substrates can on the other hand also be masks, i.e. glass plates on which structures have been or will be applied, and which serve as originals for exposing the wafers.

In the manufacture of semiconductor wafers, between certain manufacturing steps the substrates are transported in cassettes of various kinds to different workstations, where they must be introduced into the respective workstation. Transport can be accomplished manually or automatically.

The workstations serve various purposes for treatment of the substrates, such as inspection, measurement, or processing of the substrates. During inspection of the substrates, they are optically inspected in particular with regard to undesired particles on the substrates or defects in the structures on or in the surface of the substrates. Inspection can be accomplished by the user or automatically with the aid of an electronic camera. Substrate workstations used for inspection, also called wafer inspection devices, are known from the existing art, for example, under the Applicant's designations INS 3000 and INS 3300. Measurements on the substrates can also be performed in such workstations or in separate workstations. For example, the undesired particles or structure defects can be automatically detected and classified (defect analysis). The widths, spacings, or thicknesses of the structures can also be measured (CD analysis, layer thickness analysis). The inspection and measurement procedures are often completely automated in terms of both the handling of the substrates and the locations on the substrate that are to be inspected or measured.

High standards are generally applied to the handling of the substrates, for example in terms of handling reliability, speed, and cleanliness. In addition, it should also be possible to use, and introduce into the handling process, substrates having different diameters. Handling of the substrates means in this context, in particular, transfer of the substrates from a substrate conveying module into a workstation, positional changes within the workstation and during transport of the substrate, and lastly transfer back into the substrate conveying module, optionally with corresponding sorting.

A so-called substrate carrier serves for reception and handling of a substrate, substrate carriers being indispensable temporary holding and positional retention resources for the examination of semiconductor substrates in microelectronic and optoelectronic technology. The substrates to be examined are usually held in place or retained on a substrate carrier by means of negative pressure or vacuum. Substrate carriers that can retain substrates of a standardized size (at present approximately 50 to 300 mm) are usually used in production processes in the semiconductor industry.

Substrates have hitherto, as a rule, been received and handled with substrate carriers in two different ways. On the one hand, a substrate carrier receives a substrate, from below or from one side, in the center, and acts upon the substrate with negative pressure in order to retain it on the substrate carrier. Another specific substrate carrier, on the other hand, receives the substrate by grasping the substrate at the edge; this is so-called edge gripping, in an edge handling context. Usually a substrate workstation is fitted with only one type of substrate carrier, for example with substrate carriers for centered reception of a substrate. With that substrate workstation it is accordingly possible to inspect or examine, or process, only substrates that permit centered contamination of the substrate. If it is then necessary to examine, with that substrate workstation, substrates that permit only edge contamination, the substrate carrier or carriers of the workstation must be extensively replaced; in other words the substrate workstation must be reconfigured. This is complex, time-consuming, and accordingly associated with downtimes in wafer production, and therefore expensive.

### SUMMARY OF THE INVENTION

It is therefore an object of the present invention to allow substrates that permit contamination only in the edge region also to be processed, in the simplest possible fashion, using a substrate workstation embodied for the centered reception of substrates.

The aforesaid object is achieved according to the present invention with an adapter apparatus for a substrate workstation comprising at least one substrate carrier that receives from one side in substantially centered fashion, for transport and/or for handling, a substrate to be processed with the substrate workstation, wherein the adapter apparatus is reversibly adaptable to a substrate carrier of the substrate workstation; and the adapter apparatus is embodied in such a way that the substrate is receivable only substantially at its edge region by the adapter apparatus.

What has been recognized according to the present invention is that it is not necessary to replace the substrate carrier or carriers, or to reconfigure the substrate workstation. Refitting of the substrate workstation can, in very particularly advantageous fashion, be almost entirely omitted if an adapter apparatus according to the present invention can be reversibly associated with a substrate carrier. Because of the particular embodiment of the adapter apparatus, a substrate is contacted, and therefore also contaminated, only at the edge region during handling by the substrate carrier in combination with the adapter apparatus. No contamination of the substrate in its central region occurs as a result of either the substrate carrier or the adapter apparatus, since as a result of the adapter apparatus, the substrate does not come into contact with the substrate carrier. It is thus possible in simple fashion, using a substrate workstation embodied for centered reception of substrates, also to process substrates that permit contamination only at the edge region.

In a further embodiment, the adapter apparatus is embodied in such a way that it receives a substrate from one side, preferably from the underside. The substrate could accordingly, for example, be received on the substrate carrier by placement on the adapter apparatus with its edge region, and thus be transported through a substrate workstation in a manner comparable to conventional edge handling.

The substrate can be reversibly retainable on the adapter apparatus. Negative pressure, for example, could be used for retention.

In another further fashion, the adapter apparatus comprises at least one support region with which a substrate is receivable by placement. The substrate could be reversibly retainable on the adapter apparatus at the support region under its own weight and/or by means of adhesive force between the substrate and the support region. A simple and effective temporary retention of the substrate on the adapter apparatus is thereby advantageously constituted. The material of the support region could be selected in such a way that the adhesive force between the substrate and support region exhibits a definable and sufficient or suitable value for handling in a substrate workstation.

The support region could be embodied annularly over an entire periphery. It would also be possible for the support region to comprise individual annular portions or segment portions that are arranged or provided on the outer periphery of the adapter apparatus. The segment portions could be rectangular, polygonal, or circular in configuration. The segment portions could be oriented, for example, in a radial direction. It is also conceivable to arrange the segment portions displaceably in a radial direction. The adapter apparatus can thereby be adjusted to the diameter of the substrates to be processed. It is thus possible, in advantageous fashion, for substrates of different diameters to be processed by the substrate workstation.

The support region could, concretely, comprise rubber, PEEK, metal, and/or plastic. Because substrate workstations are usually operated in a clean room, it is reasonable to use clean-room-compatible material for the adapter apparatus and for the support region.

If, in the context of a substrate workstation, a conventional substrate carrier retains a substrate with the aid of negative pressure, the adapter according to the present invention could comprise a means that uses the negative pressure applicable to the substrate carrier to retain the substrate on the adapter apparatus. This means could comprise a conduit or a connecting line with which the negative pressure being applied to the substrate carrier is directable to a support region at which the substrate is resting on the adapter apparatus.

The adapter apparatus could comprise gripper means and/or clamp means with which the substrate can be gripped or clamped and thus retained on the adapter apparatus. The gripper means and/or clamp means are to that extent derived from retention means known from the existing art for edge handling of wafers or substrates. A gripper means and/or clamp means of this kind could likewise be actuatable by means of positive or negative pressure. In this case as well, at least one conduit or connecting line could be provided, with which the positive or negative pressure applicable to a substrate carrier is directable to a gripper means and/or clamp means for mechanical actuation thereof.

For reversible adaptation of the adapter apparatus according to the present invention to a substrate carrier, in a further embodiment the adapter apparatus is embodied at least partially in complementary fashion with respect to a substrate carrier. As a result, for example, the adapter apparatus can be adapted relatively easily to a substrate carrier. In a further fashion, the adapter apparatus could be embodied in such a way that a substrate carrier and an adapter apparatus adapted thereon have, in a direction perpendicular to the substrate surface, substantially the dimensions of the substrate carrier without an adapter apparatus. It is thereby possible to convey or transport the substrate, together with the adapter apparatus according to the present invention, through a substrate workstation.

Reversible retention of the adapter apparatus on a substrate carrier could be accomplished, for example by means of at least one threaded, bayonet, detent, or negative-pressure connection.

So that automated processing of the substrates by the substrate workstation can be ensured, means are provided with which it is possible to ascertain or check whether a substrate is currently being received or transported by a substrate carrier. A sensor means is accordingly provided on the substrate workstation and/or on the substrate carrier and/or on the adapter apparatus, the presence of a substrate on the adapter apparatus being detectable with that means. A sensor means of this kind could be embodied in such a way that it generates an electrical signal when a substrate is present on the adapter apparatus. The electrical signal generated by the sensor means could then be transmitted to a central control unit of the substrate workstation, which unit can process that information and correspondingly report to an operator any malfunctions that are present, or execute definable fault resolution routines.

The sensor means could detect the presence of a substrate optically, for example by way of a reflected-light measurement. It may also be useful, however, to detect the presence of a substrate electronically, for example capacitatively or inductively. Lastly, the sensor means can be specifically coordinated with the substrate workstation and with the requirements thereof.

The presence of a substrate on the adapter apparatus could furthermore be detectable on the basis of a pressure measurement. This would be relatively simple to implement if the substrate is retainable on the adapter apparatus by means of negative pressure. In this case the measurement of the presence of a substrate on the adapter apparatus would amount to a measurement of a pressure. For example, if the (negative) pressure does not fall below a definable value, no substrate is present on the adapter apparatus, or else it is not resting in the intended fashion on the adapter apparatus.

The sensor means can be embodied in such a way that the position of the substrate on the adapter apparatus can also be determined using the sensor means. Specifically, if a substrate is not positioned on the adapter apparatus in centered fashion, or in the position provided for, provision could be made for corresponding processing routines with which the substrate can be positioned centeredly with respect to the adapter apparatus, for example by re-reception of the substrate.

According to a further embodiment, a side facing toward the substrate is embodied in substantially flat fashion, and would thereby be adapted to the shape of a substrate. One or more projections, against which the outer edge of the substrate in the radial direction can come into contact, could protrude on the outer edge region of the adapter apparatus. A centered arrangement of the substrate on the adapter apparatus according to the present invention can be realized by way of this feature. Furthermore, a projection could comprise a beveled region with which a centering of the substrate relative to the adapter apparatus is attainable in simple and effective fashion.

In principle, the side of the adapter apparatus according to the present invention facing toward the substrate could be embodied in substantially oval, round, star-shaped, or cross-shaped fashion. It is possible, as indicated above with reference to an example, if the adapter apparatus is embodied in such a way that substrates of different sizes or diameters are receivable therewith. Even substrates differing in size can thus be processed using one substrate workstation.

It is conceivable that a situation exactly opposite to what has hitherto been described may exist with reference to a substrate workstation, namely such that at least one substrate carrier is provided that receives from one side substantially at the edge region, i.e. not centeredly, for transport and/or for handling, a substrate to be processed. An object corresponding to the one cited above would accordingly be achieved, in corresponding fashion, by an adapter apparatus according to the present invention, which is reversibly adaptable to a substrate carrier of the substrate workstation. This adapter apparatus is embodied in such a way that the substrate is receivable by the adapter apparatus only substantially in a central region. A substrate carrier acting at the edge region of the substrate is thus adapted to a modified substrate carrier acting centeredly. The adapter apparatus according to the present invention described at the end can accordingly be refined in corresponding fashion like the adapter apparatus described before.

In terms of a substrate workstation, the object cited above is achieved by the features of a substrate workstation according to the present invention comprising at least one substrate carrier that receives from one side in substantially centered fashion, for transport and/or for handling, a substrate to be processed with the substrate workstation.

According to the present invention, an adapter apparatus, which is reversibly adaptable to a substrate carrier of the substrate workstation, is provided.

As a result, the substrate workstation is usable, very particularly advantageously, in versatile fashion, since it is possible therewith to process or examine substrates that are received by a substrate carrier either exclusively centeredly or exclusively at the edge region, and are thus contaminated only there. To avoid repetition, the reader is referred to the foregoing portion of the description.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

There are various ways of advantageously embodying and refining the teaching of the present invention. The reader is referred to the explanation below of the preferred exemplifying embodiments of the invention with reference to the drawings. In conjunction with the explanation of the preferred exemplifying embodiments of the invention with reference to the drawings, an explanation is also given of generally preferred embodiments and refinements of the teaching. In the drawings, in a schematic depiction in each case:

FIG. 1 shows a first exemplifying embodiment of the present invention;

FIG. 2 shows a second exemplifying embodiment of the present invention; and

FIG. 3 shows a third exemplifying embodiment of the present invention.

Identical or similar components are identified in the Figures by the same reference characters.

### DETAILED DESCRIPTION OF THE PREFERRED EMBODIMENTS

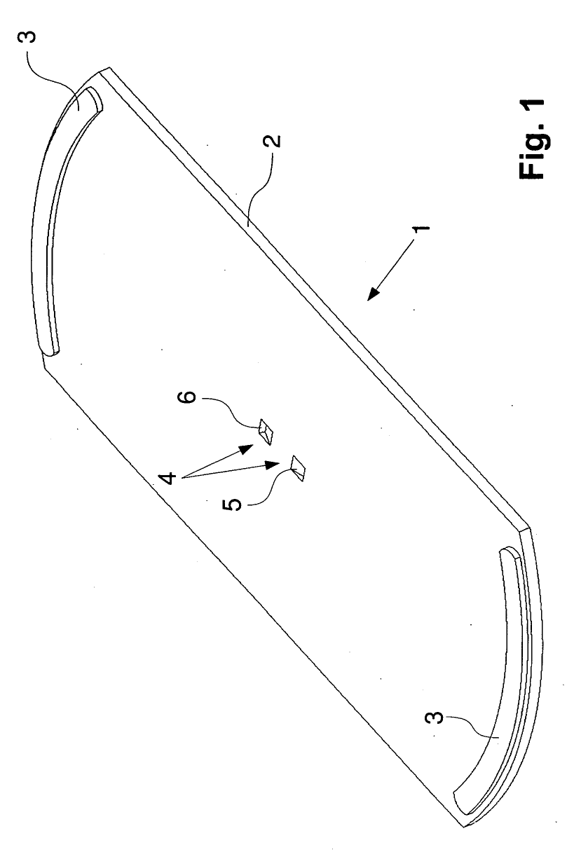

FIG. 1 shows a first exemplifying embodiment of an adapter apparatus 1 according to the present invention that serves to receive a substrate (not shown in FIGS. 1 to 3). Adapter apparatus 1 is reversibly adaptable, specifically with its lower side, to a substrate carrier (also not shown in FIGS. 1 to 3). Adapter apparatus 1 comprises a carrier 2 and a support region 3 onto which a substrate can come to rest from above, as depicted in FIG. 1. In such a case the substrate is reversibly retainable on adapter apparatus 1 as a result of both its own weight and the adhesive force between the substrate and support region 3. Support region 3 is embodied in arc-shaped fashion at the edge region of adapter apparatus 1, and does not extend over the entire periphery. Support region 3 is embodied in substantially strip-shaped fashion, and is made of clean-room-compatible PEEK.

Adapter apparatus 1 of FIG. 1 encompasses an optical sensor 4 with which the presence of a substrate on adapter apparatus 1 is detectable. Optical sensor 4 comprises a light source 5 that emits light toward the substrate at a shallow angle. Optical sensor 4 comprises a light-sensitive detector 6 that can detect the light emitted by light source 5 and reflected from the substrate.

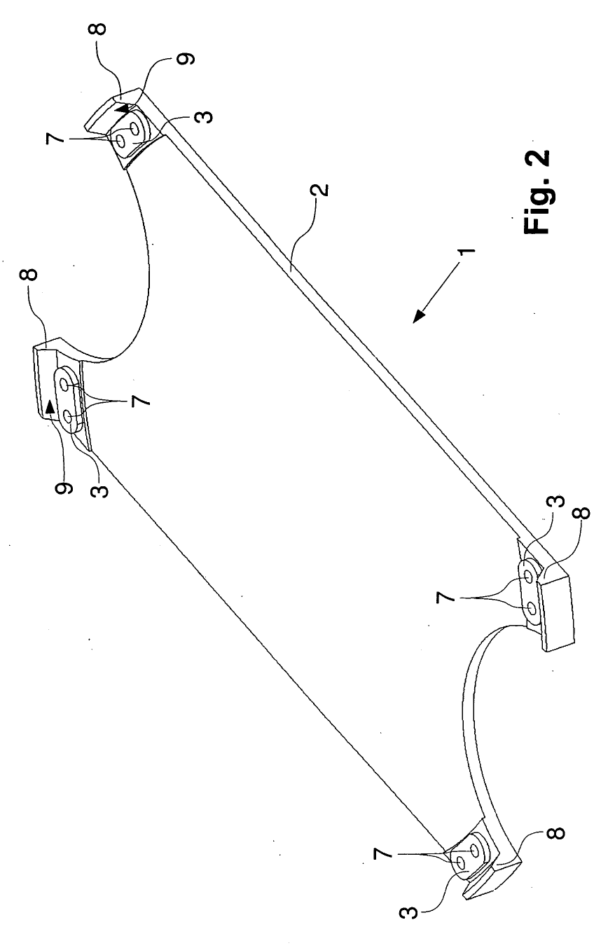

Adapter apparatus 1 as shown to FIG. 2 likewise encompasses a carrier 2 which comprises four support regions 3 that are embodied in the form of segment portions. Provided at each of the four support regions 3 are two respective orifices 7 which are connected to negative-pressure connections (not shown in FIG. 2), and through which a substrate resting on support regions 3 can be acted upon by negative pressure so that the substrate is thereby reversibly retainable on adapter apparatus 1. The presence of a substrate on an adapter apparatus according to FIG. 2 is detected on the basis of a pressure measurement using a pressure sensor (not shown in FIG. 2). Specifically, when the negative pressure applied to all the orifices 7 exceeds a definable value, a substrate is retained on adapter apparatus 1. Protruding at the outer rim of support 2 are respective projections 8 that each comprise an inwardly directed beveled region 9. A substrate coming to rest on adapter apparatus 1 comes into contact with its outer edge, in a radial direction, against beveled regions 9, and is thereby centered with reference to adapter apparatus 1 and carrier 2. The external dimensions of the substrate correspond, in this context, to the three-dimensional arrangement of projections 8 and of beveled regions 9.

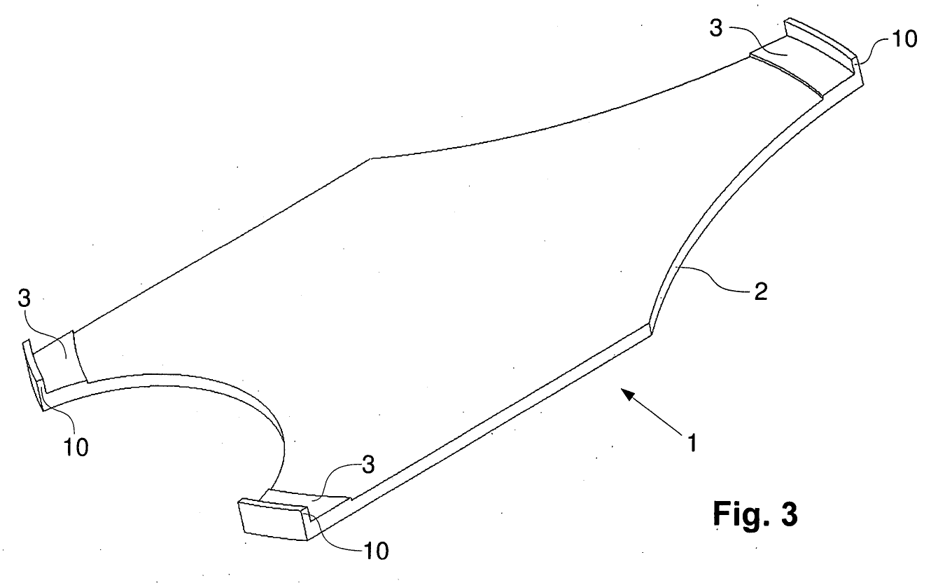

FIG. 3 shows a further exemplifying embodiment of an adapter apparatus 1 that comprises a carrier 2 and three support regions 3. According to this exemplifying embodiment, support regions 3 are produced from the same material as carrier 2. Provided at the edge region of support regions 3 are respective clamps 10 whose upper ends can be pivoted, about a substantially tangentially oriented axis arranged on carrier 2, from outside to inside and vice versa. Purely for the sake of simple presentation, clamps 10 are shown in the form of elevations or projections. The presence of a substrate on adapter apparatus 1 of FIG. 3 is detected with an electrical sensor (not depicted).

In conclusion, be it noted very particularly that the exemplifying embodiments discussed above serve merely to describe the teaching claimed, but do not limit it to the exemplifying embodiments.

While this invention has been particularly shown and described with references to preferred embodiments thereof, it will be understood by those skilled in the art that various changes in form and details may be made therein without departing from the scope of the invention encompassed by the appended claims.

What is claimed is:

1. An adapter apparatus for a substrate workstation, the adapter apparatus comprising:
at least one substrate carrier that receives from one side in substantially centered fashion, for transport and/or for handling, a substrate to be processed with the substrate workstation, wherein
the adapter apparatus is reversibly adaptable to a substrate carrier of the substrate workstation;
and the adapter apparatus is embodied in such a way that the substrate is receivable only substantially at its edge region by the adapter apparatus.

2. The adapter apparatus according to claim 1 comprising a reception of the substrate from one side, preferably from the underside.

3. The adapter apparatus according to claim 1, wherein the substrate is reversibly retainable, preferably by means of negative pressure, on the adapter apparatus.

4. The adapter apparatus according to claim 1 comprising at least one support region with which a substrate is receivable by placement; and in that preferably the substrate is reversibly retainable on the adapter apparatus at the support region because of the weight of the substrate and/or by means of adhesive force of the substrate on the support region.

5. The adapter apparatus according to claim 4, wherein the support region embodied annularly over an entire periphery; or the support region comprises individual annular portions or segment portions.

6. The adapter apparatus according to claim 5, wherein the segment portions are rectangular, polygonal, or circular in configuration.

7. The adapter apparatus according to claim 4, wherein the support region comprises preferably clean-room-compatible rubber, PEEK, metal, and/or plastic.

8. The adapter apparatus according to claim 1, comprising a substrate carrier being actable upon by negative pressure in order to retain a substrate, and means that uses the negative pressure being applied to the substrate carrier to retain the substrate on the adapter apparatus.

9. The adapter apparatus according to claim 8, wherein the means comprises a conduit or a connecting line with which the negative pressure being applied to the substrate carrier is directable to a support region at which the substrate is resting on the adapter apparatus.

10. The adapter apparatus according to claim 1, comprising a gripper means and/or clamp means with which the substrate can be gripped or clamped, with the result that the substrate is retainable on the adapter apparatus.

11. The adapter apparatus according to claim 10, wherein a gripper means and/or clamp means is actuatable by means of positive or negative pressure, at least one conduit or connecting line being provided, with which the positive or negative pressure being applied to the substrate carrier is directable to a gripper means and/or clamp means.

12. The adapter apparatus according to claim 1, comprising at least a partially complementary embodiment with respect to a substrate carrier, the adapter apparatus preferably being embodied in such a way that a substrate carrier and the adapter apparatus (1) adapted thereon have substantially the dimensions of the substrate carrier without an adapter apparatus (1).

13. The adapter apparatus according to claim 12, wherein the adapter apparatus being embodied in such a way that a substrate carrier and the adapter apparatus adapted thereon have substantially the dimensions of the substrate carrier without an adapter apparatus.

14. The adapter apparatus according to claim 1, comprising reversible retention on a substrate carrier by means of at least one threaded, bayonet, detent, or negative-pressure connection.

15. The adapter apparatus according to claims 1, comprising a sensor means provided on the substrate workstation and/or the substrate carrier and/or the adapter apparatus with which the presence of a substrate on the adapter apparatus is detectable.

16. The adapter apparatus according to claim 15, wherein the sensor means detects the presence of a substrate optically, for example by way of a reflected-light measurement, or electronically, for example capacitatively or inductively.

17. The adapter apparatus according to claim 15, wherein the presence of a substrate on the adapter apparatus is detectable on the basis of a pressure measurement, in particular when the substrate is retainable on the adapter apparatus by means of negative pressure.

18. The adapter apparatus according to claims 15, wherein the position of the substrate on the adapter apparatus can be determined with the sensor means.

19. The adapter apparatus according to claim 1, comprising a side that faces toward the substrate and is embodied in substantially flat fashion, in which context a projection, against which the outer edge of the substrate in the radial direction can come into contact, protrudes at the outer edge region of the adapter apparatus.

20. The adapter apparatus according to claim 19, wherein the projection comprises beveled regions with which a centering of the substrate relative to the adapter apparatus is attainable.

21. The adapter apparatus according to claim 1, comprising a substantially oval, round, star-shaped, or cross-shaped embodiment of the side of the adapter apparatus facing toward the substrate.

22. The adapter apparatus according to claim 1, wherein the adapter apparatus is embodied in such a way that substrates of different sizes or diameters are receivable therewith.

23. An adapter apparatus for a substrate workstation, the substrate workstation comprising:
at least one substrate carrier that receives from one side substantially at the edge region, for transport and/or for handling, a substrate to be processed with the substrate workstation,
wherein the adapter apparatus is reversibly adaptable to a substrate carrier of the substrate workstation; and the adapter apparatus is embodied in such a way that the substrate is receivable by the adapter apparatus only substantially in a central region.

24. A substrate workstation comprising:
at least one substrate carrier that receives from one side in substantially centered fashion, for transport and/or for handling, a substrate to be processed with the substrate workstation,
wherein an adapter apparatus is reversibly adaptable to a substrate carrier of the substrate workstation.
